(19) United States
(12) Patent Application Publication
(10) Pub. No.: US 2002/0051839 A1
(43) Pub. Date: May 2, 2002

(54) METHOD AND APPARATUS FOR ROASTING AND COOLING BEANS

(76) Inventors: KIICHIRO SHINKAWA, KOBE-SHI (JP); OSAMU NAKAGIRI, KOBE-SHI (JP); YASUTAKA KATSURAGI, TOKYO (JP); HISATAKA ASAMI, TOKYO (JP)

Correspondence Address: CROWELL & MORING LLP, INTELLECTUAL PROPERTY GROUP, P.O. BOX 14300, WASHINGTON, DC, 20044-4300, US

(21) Appl. No.: 09/104,398

(22) Filed: Jun. 25, 1998

(30) Foreign Application Priority Data
Jun. 25, 1997 (JP) 9-184390

(51) Int. Cl. A23L 1/00

(52) U.S. Cl. 426/466; 426/465; 99/324

(57) ABSTRACT

In a method and apparatus for roasting and cooling coffee beans, in which suppress as much as possible the dispersion of aroma components contained in roasted coffee beans right after roasting or gases and also chemical changes, thereby providing coffee beans having far improved quality compared to the prior art products, the cooling unit is characteristic of forming a sealed cooling space, which comprises gas-tight cooling vessel, dust collector unit, cold air generator and air circulation path connecting together these components and sealing them from external atmosphere.

### BACKGROUND OF THE INVENTION

1. Field of the Invention

The present invention relates to a method and an apparatus for roasting and cooling beans at low cost, in which particular considerations are given to a cooling step right after roasting such as to obtain high level aroma and flavor of roasted coffee beans.

2. Description of the Prior Art

Conventional roasted coffee beans manufacture comprises a roasting step of beans and a cooling step right thereafter.

In the above roasting step, coffee beans is roasted with hot air at 400 to 500° C. in a hot air drum roaster for about 10 minutes to obtain roasted coffee beans at about 200° C.

In the subsequent cooling step, the coffee beans right after the roasting is cooled down by air cooling for about 5 minutes to normal temperature of about 20° C.

The flavor of coffee which is obtained in the above roasting and cooling steps is attributable to many chemical components that are generated in the beans by the roasting.

a) However, the flavor is changed with dispersion of and chemical changes in components with the lapse of time after the roasting.

b) In addition, the remaining heat right after the roasting may cause dispersion of aroma components or progress of secondary roasting, giving rise to roasting unevenness.

c) Furthermore, while fresh coffee has rich aroma and great swelling of its flour is caused by pouring hot water into the flour of coffee at the time of the dripping, old coffee less swells at the time of the dripping and has a poor aroma.

The swelling of coffee at the time of the dripping is presumed to be owing to carbonic acid gas contained in the roasted coffee beans. As the roasted coffee beans becomes older, carbonic acid gas progressively disperses together with aroma components, and the carbonic acid gas content in roasted coffee beans represents the degree of aroma.

As shown above, the aroma and flavor of coffee are attributable to dispersion of aroma components after the roasting and carbonic acid gas or chemical changes, and also remaining heat after the roasting poses problems. In consequence, it is thought that problems reside in the cooling treatment right after the roasting and also in custody subsequent to the cooling treatment.

In the conventional cooling treatment, a temperature of about 200° C. right after the roasting is cooled down to normal temperature of 20° C. by using an air-cooling apparatus.

Concerning such cooling apparatus, invention A is disclosed in, for instance, Japanese Patent Publication No. 57-21372.

FIG. 3 shows the cooling apparatus 70 according to invention A. Dashed line 66 represents a cold air circulation path, to which a cooling vessel 65, a fan 56 and a dust collector 61 are connected as shown by arrow A. Dashed line 67 represents an exhausting path, through which exhaust gas from a filtering type dust collector 62 having a filter 62a is released through a deodorizer 63 to atmosphere as shown by arrow B.

Exhaust gas withdrawn from the cooling vessel 65 is passed for dust removal through the dust remover 61, and then returned to the cooling vessel 65. This circulation loop is shown by dashed line 66. A portion of the exhaust gas circulated in the circulation loop 66 is led through the exhausting path represented by dashed line 67 so as to join a releasing path, through which dust removed exhaust gas being led via a fan 54, a centrifugal dust collector 60 and a fan 55 from a roasting chamber 51 is passed, thereby the joint exhaust gas is led to be released to the atmosphere after deodorizing in the deodorizer 63 through the filterizing type dust collector 62.

In this case, during cooling no roasting is made, and no exhaust gas comes out from the roasting chamber 51. Thus, it is made so as to be possible to employ a deodorizer having a capacity corresponding to the amount of exhaust gas from the roasting chamber, which is far less than the exhaust amount of cooling gas.

That is, according to invention A the exhaust gas generated from the cooling vessel during cooling is re-circulated by removing dust, and the re-circulated exhaust gas, while doing dust removal, is deodorized and released to atmosphere at a low rate. In this case, during cooling it is necessary to deodorize a great amount of exhaust gas. To this end, a high capacity deodorizer is necessary, and invention A has been proposed as a means for solving this problem.

Concerning another example of cooling apparatus, invention B is disclosed in Japanese Patent Publication No. 4-21465.

According to invention B, an air cooling vessel is provided for cooling roasted beans right after roasting. In this cooling apparatus, for a short period of time right after the start of cooling, during this time bad odor is produced, cooled exhaust gas from the cooling vessel is released to atmosphere after deodorizing through a deodorizer.

At a later time, the cooled exhaust gas is not deodorized but is directly released to the atmosphere.

In the former prior art case, the rate of flow of cooling air is held low, and it is permitted to deodorize the cooling exhaust gas by commonly using a low exhaust rate deodorizer which is also used for the exhaust gas from the roasting chamber in the roasting step. In the latter prior art case, in which no deodorizer is used, the rate of flow of cooling air is increased to promote cooling of roasted beans by cooling with high air flow rate and permit retaining the aroma.

More specifically, according to invention B while ensuring sufficiently cooling an air flow rate to retain the aroma of the roasted beans, only part of the cooled exhaust gas that contains much bad odor in an initial stage after the start of the cooling is released to atmosphere by using the deodorizer, and the subsequent cooled exhaust gas is directly released to atmosphere.

Recently, it has further been in practice to blow fresh air from the outside into a cooling vessel so as to use more exhaust gas than three times the exhaust gas in the roasting step for air cooling of the roasted beans through a dust remover, in which exhaust gas is partly directly released to atmosphere and partly released to atmosphere through the deodorizer.

Concerning a further example of cooling apparatus, invention C is disclosed in Japanese Patent Publication No. 7-110200.

Invention C features quick cooling roasted coffee beans down to −17 to −35° C. within 3.5 minutes after roasting and wrapping the cooled coffee beans in a gas-tight vessel without degassing any gas. The invention thus has an object of preventing deterioration of the aroma of the roasted beans.

The gas degassing noted above has an aim of degassing carbonic acid gas by preserving the roasted coffee beans in a gas-tight silo for 122 hours to 4 days.

### SUMMARY OF THE INVENTION

<Object>

An object of the present invention, as specified in claims 1 and 2, is to provide a method of roasting and cooling beans which permits prevention of dispersion of aroma components of roasted beans and also exhalation of gases, particularly provide a cooling means.

In the prior art techniques, various improvements are proposed concerning the promotion of cooling and removal of bad odor for roasting and cooling coffee beans. However, no measure against the following matters in the cooling step right after the roasting was provided.

That it, as above-mentioned, concerning the deterioration of the aroma and flavor of coffee, it is thought that a radical measure is necessary against the cooling treatment after the roasting in considerations of such problems as the dispersion of aroma components, the exhalation of gases and the progress of chemical change due to a great deal of cooled exhaust gas stream particularly in the cooling right after the roasting and also the problem of roasting unevenness resulting from remaining heat after the roasting.

The present invention was made in view of the above problems, and seeks to provide a method and an apparatus for roasting and cooling beans, which suppress as much as possible the dispersion of aroma components contained in roasted beans and exhalation of and chemical changes in gases in the step of cooling roasted beans executed right after the roasting, thereby providing coffee beans having quality far improved compared to the prior art product.

Another object of the present invention as claimed in claim 3 is to provide a method of roasting and cooling beans, wherein beans are deodorized only in a roasting step executed prior to the cooling of the roasted beans.

A further object of the present invention as claimed in claim 4 is to provide an apparatus for roasting and cooling beans, which comprises cooling means of roasted beans and perching means of beans permitting suppression of the dispersion of aroma components and exhalation of gases.

A yet further object of the present invention as claimed in claim 5 is to provide an apparatus for roasting and cooling beans, wherein deodorizing of beans during roasting and cooling beans is operated only in the roasting step.

<Constitution>

According to the invention as claimed in claim 1, a method of roasting and cooling beans is provided, which comprises the step of treatment for roasting and cooling beans, wherein perched beans are quickly cooled by causing circulation of cold air for cooling in a state isolated from external atmosphere, thereby suppressing dispersion of aroma and blocking discharge of gas containing aroma-components generated during cooling to the atmosphere to let the aroma-containing gas be confined in the beans being cooled.

Specifically, in the cooling method according to the invention, the roasted beans is cooled in the isolated space with cold air circulated therein for cooling, whereby aroma components and gas containing these aroma components, generated during the cooling, are prevented from dispersion by exhalation and confined in the roasted beans.

According to the invention as claimed in claim 2, the cold air according to claim 1 is low temperature cold air at 10° C. or below, thus permitting reduction of cooling time and cooling air amount and minimizing generation of gas containing aroma components.

According to the invention as claimed in claim 3, a method of roasting and cooling beans is provided, which comprises the step of treatment of roasting and cooling beans, wherein beans are deodorizing only in a roasting step.

Specifically, in the cooling method according to the present invention, commonly termed bad odor generated during cooling is not removed but is confined in the sealed space, in which cold air for cooling is circulated.

According to the invention as claimed in claim 4, an apparatus for roasting and cooling beans is provided, which comprises roasting means including a roaster for thermally roasting beans, a dust remover for removing ash and dust in a roasting step and a deodorizer for deodorizing roasting exhaust gas after dust removal, and cooling means for cooling roasted beans, wherein the cooling means includes a cooling vessel, a cold air generator, a dust remover and a closed cold air circulation path connecting these components.

According to the invention as claimed in claim 5, the deodorizer according to claim 4 is operated only in a roasting step.

### BRIEF DESCRIPTION OF THE DRAWINGS

FIG. 1 is a block diagram outlining a roasting and cooling apparatus for carrying out a method of roasting and cooling beans according to the present invention.

FIG. 2 is a schematic view showing a test cooling apparatus designed on the basis of the roasting and cooling apparatus shown in FIG. 1.

FIG. 3 is a schematic view showing a prior art beans roasting and cooling apparatus.

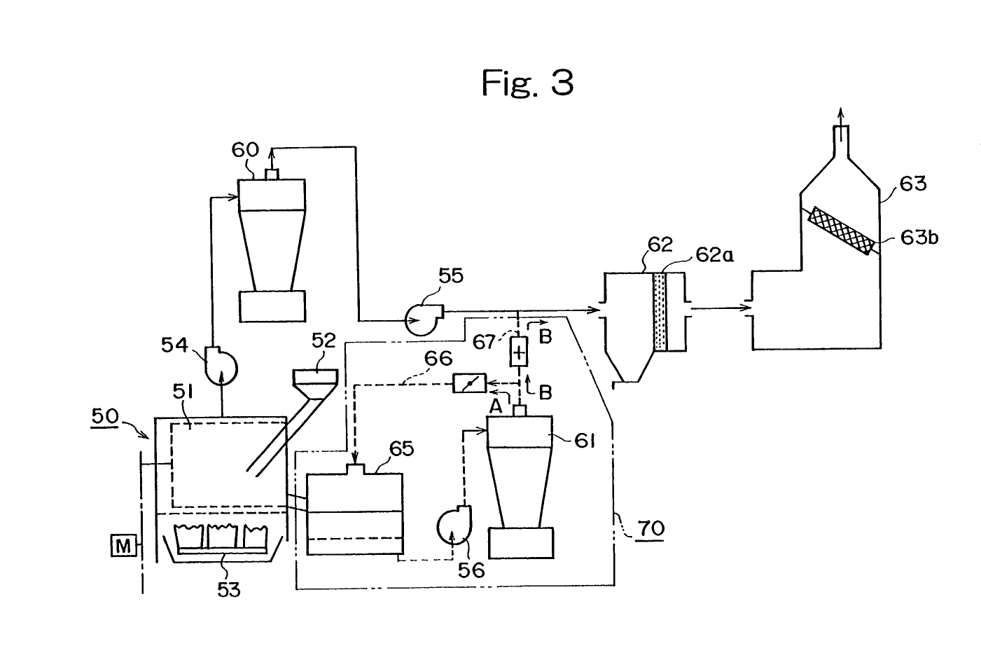

FIG. 4 shows the test condition of typical example in the embodiment of the invention.

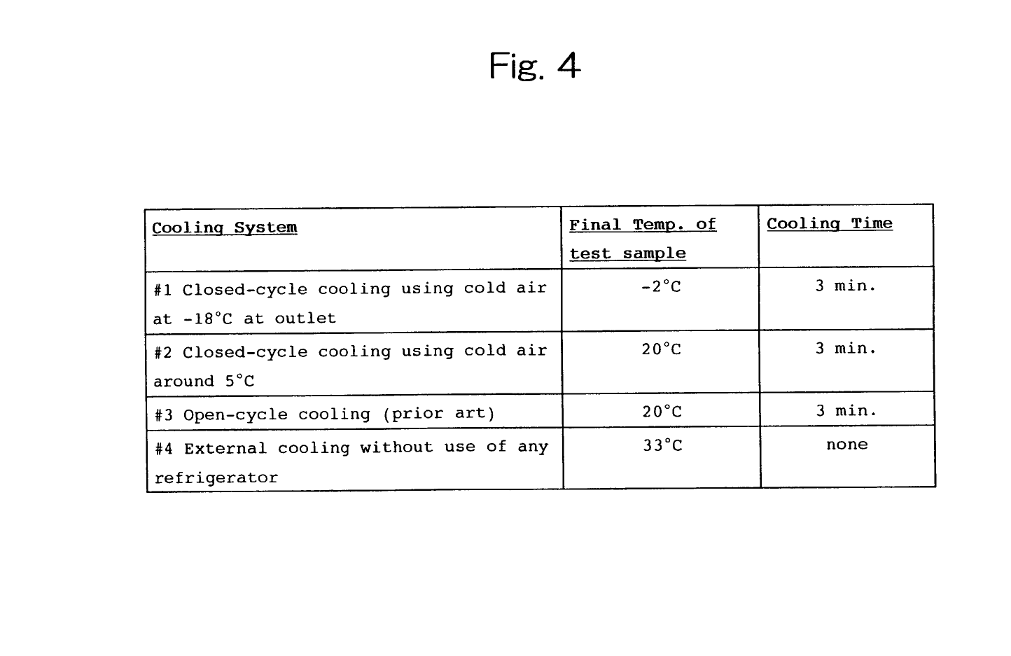

### DETAILED DESCRIPTION OF THE PREFERRED EMBODIMENT

An embodiment of the present invention will now be described together with an illustrated example. It is to be construed that unless particularly specified the sizes, shapes, relative positions and so forth of the components described in connection with the embodiment have no sense of limiting the scope of the present invention but are merely exemplary.

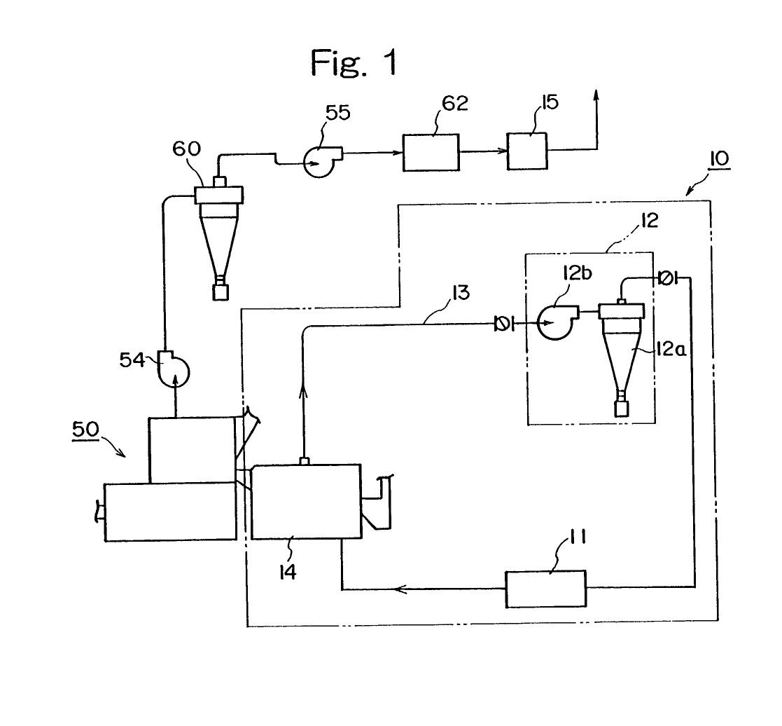

FIG. 1 is a block diagram outlining a roasting and cooling apparatus for carrying out a method of roasting and cooling beans according to the present invention.

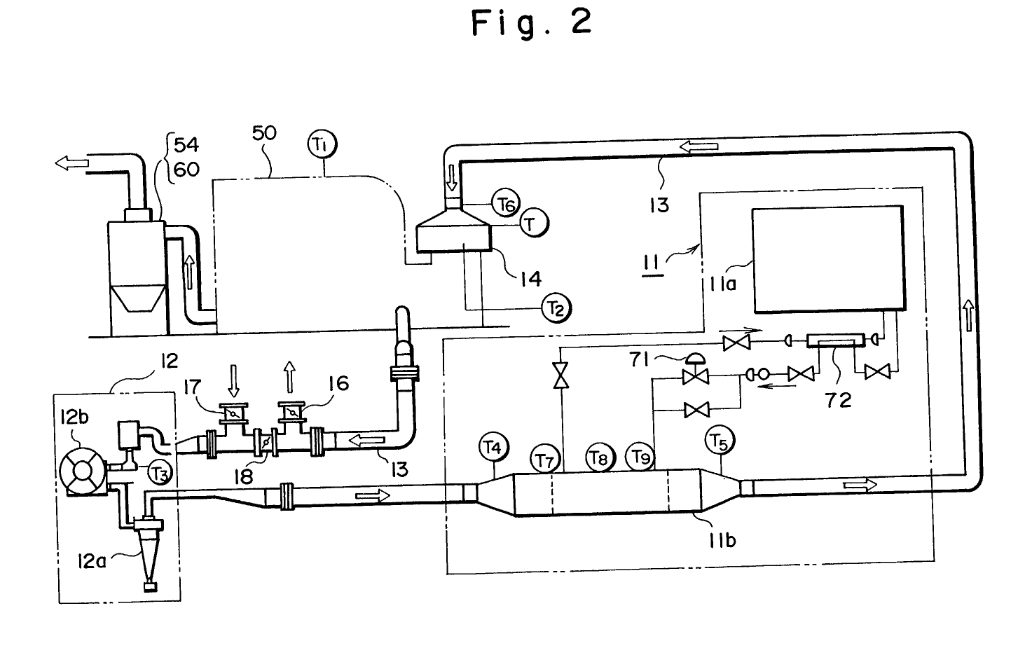

FIG. 2 is a schematic view showing a test apparatus designed on the bases of the cooling apparatus shown in FIG. 1.

In the method of roasting and cooling beans according to the present invention, deodorizing is operated only in a roasting step, and exhaust gas generated from a roasting chamber is released through a duct collector, a filter and a deodorizer to external atmosphere.

On the one hand, right after the roasting, the roasted beans are quickly cooled in a state being interposed in a sealed space, in which compressed cold air for cooling is circulated in the isolated state from external atmosphere. Thus, separation of aroma components and carbonic acid gas containing these components is minimized with reduction of cooling time and circulated air amount, and the aroma-containing gas is prevented from dispersion to the outside due to the sealed space and confined in the roasted beans.

At the time of the cooling, the cooling operation is made in the close sealed space including a cold air circulation path, and unlike the prior art deodorization etc. are not fully exhausted.

As shown in FIG. 1, the roasting and cooling apparatus for carrying out the method of roasting and cooling beans comprises a roasting unit, which includes a roaster 50, a fan 54 for withdrawing exhaust gas from the roaster 50, a centrifugal dust collector 60 for removing dust from the exhaust gas through the fan 54, a filtering type dust collector 62 for collecting dust in the dust removed exhaust gas through a fan 55 and a deodorizer 15 for deodorizing the exhaust gas after the dust collection, and a cooling unit 10.

The cooling unit 10 includes a cooling vessel 14, a dust collector unit 12 having a high pressure fan 12b and a dust collector 12a, a cold air generator 11 and a cold air circulation path 13 connecting together these components. A close sealed cooling space which doe not use any conventional open type deodorizer, is formed by the gas-tight cooling vessel 14, dust collector unit 12, cold air generator 11 and cold air circulation path 13 connecting together these components.

FIG. 2 schematically shows a test cooling apparatus designed on the basis of the above cooling apparatus. As shown, the cold air generator 11 includes a condensing unit 11a and a heat exchanger 11b. Cold air is held at a temperature of substantially −18° C. at the outlet of the heat exchanger 11b, and forced to ventilate under pressure by a cold air circulating fan provided on the inlet side of the heat exchanger 11b. The condensing unit 11a is a refrigerator, and the heat exchanger 11b is fin type heat exchanger. Cold air for cooling in the cold air circulation path 13 is forced out under high pressure by the duct collector unit 12.

In the cold air circulation path 13 of the test cooling apparatus shown in FIG. 2, an external exhausting valve 16, an atmospheric air in-taking valve 17 and an intermediate cut-off valve 18 are provided for judging the performance of various trial cooling system products.

Using the above test cooling apparatus, various tests were made repeatedly, and the quality of roasted coffee beans samples was evaluated. It was found that the quality is extremely improved when the temperature of the circulated air is reduced to 10° C. or below. Thus, in the embodiment of the invention, closed-cycle cooling should be made at a low temperature of 10° C. or below. FIG. 1 shows results of four typical test examples of cooling.

Example #1 is closed-cycle cooling using cold air at an outlet in a temperature of −18° C.

Example #2 is closed-cycle cooling using cold air in a temperature of around 5° C.

Example #3 is open-cycle cooling (prior art).

Example #4 is external cooling without use of any refrigerator.

In Examples #1 and #2, satisfactory results could be obtained, and were quite superb compared to the results of the other test examples. This means that it is suitable to make closed-cycle cooling in a temperature of 10° C. or below.

Thermometers T1; T; T2; T3; T4; T7; T8; T9; T5; T6 are provided respectively for temperature control of the test cooling apparatus in the roasting chamber 50, in the cooling vessel 14, at the outlet thereof, at the inlet of the fan 12b, at the inlet, center having three positions and outlet of the fin type heat exchanger 11b and at the inlet of the cooling vessel 14.

In the cooling apparatus 10, roasted beans right after the roasting are quickly cooled by low temperature cold air generated from the cold air generator 11 provided in the sealed space formed closely in the cold air circulation path 13. It is thus possible to suppress chemical changes in aroma components in the roasted beans, suppress generation of volatile components containing aroma components and eliminate roasting unevenness due to quick removal of remaining heat after the roasting.

Furthermore, since the roasted beans are cooled by a cold air stream circulated under high pressure in the sealed space, aroma components and carbonic acid and like gases containing the aroma components are prevented from dispersion and confined in the beans.

As shown in FIG. 1, the cooling unit 10 has no branch path from the cold air circulation path 13 to the filtering type dust collector 62 and deodorizer 15 in the roasting Unit. The deodorizer 15 is adapted to be used only in the roasting step, and this also contributes to running cost reduction.

The construction as described above permits holding particularly rich aroma components and flavor of roasted beans such as coffee beans, and contributes to running cost reduction owing to non-use of any deodorizer at the time of the cooling.

1. A method of roasting and cooling beans comprising the step of treatment for roasting and cooling beans, wherein roasted beans are quickly cooled by causing circulation of cold air for cooling in a state isolated from external atmosphere, thereby suppressing dispersion of aroma and blocking discharge of gas containing aroma-components generated during cooling to the atmosphere to let the aroma-containing gas be confined in the beans being cooled.

2. The method of roasting and cooling beans according to claim 1, wherein the cold air is low temperature cold air at 10° C. or below.

3. A method of roasting and cooling beans comprising the step of treatment for roasting and cooling beans, wherein beans are deodorizing only in a roasting step.

4. An apparatus for roasting and cooling beans comprising roasting means including a roaster for thermally roasting beans, a dust remover for removing ash and dust in a roasting step and a deodorizer for deodorizing roasting exhaust gas after dust removal, and cooling means for cooling roasted beans, wherein:
the cooling means includes a cooling vessel, a cold air generator, a dust remover and a closed cold air circulation path connecting these components.

5. The apparatus for roasting and cooling beans according to claim 4, wherein the deodorizer is operated only in a roasting step.
